(19) United States
(12) Patent Application Publication
(10) Pub. No.: US 2011/0024681 A1
(43) Pub. Date: Feb. 3, 2011

(54) TITANIUM OXIDE-CONTAINING AGGLOMERATE FOR PRODUCING GRANULAR METALLIC IRON

(75) Inventors: Takeshi Sugiyama, Kobe-shi (JP); Isao Kobayashi, Kobe-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Kobe Seiko Sho (Kobe Steel, Ltd)

(21) Appl. No.: 12/937,121

(22) PCT Filed: Apr. 9, 2009
(86) PCT No.: PCT/JP09/57254

§ 371 Date: Oct. 8, 2010

(30) Foreign Application Priority Data
Apr. 10, 2008 (JP) 2008-102620

(51) Int. Cl. C09K 3/00

(52) U.S. Cl. 252/182.33

(57) ABSTRACT

An object of this invention is to provide a titanium-containing agglomerate for producing granular metallic iron. The agglomerate is useful for obtaining a high yield of high-quality granular metallic iron in a size that is suitable for handling by using an iron source containing titanium oxide and other gangue components and heating at a relatively low temperature. The agglomerate contains: an iron source including titanium oxide of at least 5 mass % but less than 10 mass % in terms of TiO₂-equivalent content; and a carbonaceous reductant, wherein the agglomerate has a chemical composition satisfying a condition set forth in formulas (1) to (3) below,

[CaO]/[SiO₂]=0.6 to 1.2 (1)

[Al₂O₃]/[SiO₂]=0.3 to 1.0 (2)

[TiO₂]/([CaO]+[SiO₂]+[MgO]+[Al₂O₃])<0.45 (3).

Each of [CaO], [SiO₂], [Al₂O₃], [TiO₂] and [MgO] represents content (mass % on dry basis) of each component in the agglomerate.

### TECHNICAL FIELD

The present invention relates to a titanium oxide-containing agglomerate for producing granular metallic iron, and more particularly, to an agglomerate which contains as a raw material an iron source that includes titanium oxide in a specific proportion and which is useful for obtaining granular metallic iron by thermally reducing and melting iron oxide.

### BACKGROUND ART

In iron-making processes, there is a method which includes: a process of producing a compact obtained by compressing a mixture or a carbon composite compact obtained by forming the mixture into a pellet or a briquette, using as raw material the mixture that includes an iron oxide-containing material (iron source) such as iron ore and a carbonaceous reductant such as coal; a process of heating the compact in a thermal furnace to thereby solid-reduce the compact and coalescing metallic iron thus formed while separating the metallic iron from slag formed as a by-product; and a process of cooling and solidifying the coalesced metallic iron to produce granular metallic iron.

Among such iron sources are those in which the content of titanium oxide (hereinafter, also referred to as “TiO₂”) is relatively high and which contain gangue components other than TiO₂ (e.g., Al₂O₃, MgO) (hereinafter, such an iron source is also referred to as a “titanium oxide-containing iron source”).

When such a titanium oxide-containing iron source is used in the above method for producing granular metallic iron, it is necessary to melt the titanium oxide and other gangue components. Because TiO₂, Al₂O₃ and MgO as the above gangue components are components which elevate the melting temperature, high-temperature heating at 1550° C. or above is required for melting. However, heating at such elevated temperatures leads to an increase in energy consumption and a steep rise in melting furnace construction costs. Hence, this approach is not economically feasible as an iron-making process.

Patent Document 1 shows, as an example in which iron oxide ore having a relatively high TiO₂ content is used, a method for producing titanium oxide-containing slag efficiently from a material including titanium oxide and iron oxide. Specifically, the method comprises: heating at from 1200 to 1500° C. an agglomerate obtained by mixing a material which contains titanium oxide and iron oxide with a carbon-containing material (carbonaceous reductant) and then forming the resulting mixture; charging into an electric furnace and additionally heating therein the agglomerate in a state where the iron oxide has been reduced by the above heating to thereby melt the reduced iron; and then, separating the agglomerate into titanium-containing slag and molten iron. Patent Document 1 also shows that adding CaO is effective for the above melting and separation, and that the basicity (CaO/SiO₂) is set to 1.1 in the working examples. Moreover, paragraph [0020] of Patent Document 1 describes that “it is preferable for the content of natural ilmenite in the raw material mixture to be low, because gangue components (oxides other than of iron oxide) other than TiO₂ in natural ilmenite enter the titanium slag and become a major factor lowering the titanium purity.”

In the method described in Patent Document 1, to avoid a decline in the TiO₂ content within the titanium-containing slag, only CaO is added as an additive. However, with the addition of only CaO, sufficient separation of the slag and the metallic iron on the hearth is presumed to be impossible. Moreover, Patent Document 1 does not clearly show the composition of the agglomerate, and so a method for obtaining metallic iron in a cost-effective yield is not fully realized.

Patent Document 2 discloses an apparatus and a method for producing titanium oxide-enriched molten slag and molten iron by charging a pre-reduced iron-containing low-titanium material and an agglomerate thereof into a melting-capable rotary hearth furnace.

Patent Document 2 describes that CaO may be added as a flux to the agglomerate prior to preliminary reduction, but that doing so is not desirable because it lowers the titanium content in the slag. Patent Document 2 also describes that titanium oxide is present as an ingredient of the raw materials in an amount of 70% or less, and that CaO is added for the purpose of sulfur absorption, although no mention is made of the detailed chemical composition of the agglomerate. In other words, Patent Document 2 does not indicate a concrete method for obtaining metallic iron in a cost-effective yield.

Moreover, in the method of Patent Document 2, the operating temperature of the rotary hearth melting furnace is from 1300 to 1800° C., which is very broad. Because a melting process which involves raising the heating temperature is economically undesirable, it would be advantageous to separate the slag and the metallic iron in a high yield at the lowest possible temperature. However, the method described in Patent Document 2 does not take this point into account.

Thus, in none of the abovementioned prior art has there been established a method for obtaining, under relatively low-temperature heating, suitable granular metallic iron (e.g., granular metallic iron having a particle size of at least 3.35 mm; that is, granular metallic iron which does not pass through a screen having a mesh size of 3.35 mm) in a high yield (e.g., at least 80%) while using a titanium oxide-containing iron source that includes, in addition to TiO₂, the gangue components which increase the melting temperature such as Al₂O₃ and MgO.
Patent Document 1: Japanese Patent Application Publication No. 2004-131753
Patent Document 2: U.S. Pat. No. 6,685,761(B1)

### DISCLOSURE OF THE INVENTION

An object of the present invention is to provide, in cases where a titanium oxide-containing iron source that includes, in addition to titanium oxide (TiO₂), the gangue components which increase the melting temperature such as Al₂O₃ and MgO is used in the production of granular metallic iron, a titanium oxide-containing agglomerate for producing granular metallic iron that is useful for obtaining a high yield of high-quality granular metallic iron of the above-indicated size by reducing and melting iron oxide via heating at a relatively low temperature compared with conventional processes.

This titanium oxide-containing agglomerate for producing granular metallic iron comprises: an iron source including titanium oxide of at least 5 mass % but less than 10 mass % in terms of TiO₂-equivalent content; and a carbonaceous reductant, wherein the agglomerate has a chemical composition satisfying a condition set forth in formulas (1) to (3) below,

[CaO]/[SiO₂]=0.6 to 1.2 (1)

[Al₂O₃]/[SiO₂]=0.3 to 1.0 (2)

[TiO₂]/([CaO]+[SiO₂]+[MgO]+[Al₂O₃])<0.45 (3).

Each of [CaO], [SiO₂], [Al₂O₃], [TiO₂] and [MgO] in the above-mentioned formulas (1) to (3) represents content (mass % on dry basis) of each component in the agglomerate.

[TiO₂] corresponds to the above-mentioned TiO₂-equivalent content, and refers to, in cases where the agglomerate includes not only TiO₂ but also other titanium oxides such as Ti₂O₃ or TiO, the content which is obtained by converting statuses of these other titanium oxides into status of TiO₂ is also added in the TiO₂-equivalent content. Specifically, this [TiO₂] (TiO₂-equivalent content), assuming that metallic titanium is not also present, may be calculated from the following formula (4).

[TiO₂] (wt %)=content of all the titanium (wt %)/(atomic weight of titanium)×{(atomic weight of titanium)+2×(atomic weight of oxygen)} (4)

[CaO] represents sum of a content obtained by converting status of calcium included in the titanium oxide-containing iron source and the carbonaceous reductant into status of CaO, a content obtained by converting status of calcium in the fluorite which may be added as the fluorine-containing material into status of CaO, and a content obtained by converting status of calcium in the calcined lime and limestone (CaCO₃) which may be added as modifiers into status of CaO. Specifically, this [CaO], assuming that metallic calcium is not also present, may be calculated from the following formula (5).

[CaO] (wt %)=content of all the calcium (wt %)/(atomic weight of calcium)×{(atomic weight of calcium)+(atomic weight of oxygen)} (5)

This agglomerate makes it possible to produce in a good yield, and at a relatively low heating temperature, high-quality granular metallic iron of a size that is suitable for handling, even in cases where an iron source containing TiO₂ and other gangue components is used in the production of the granular metallic iron. As a result, not only are the fuel costs for heating reduced, it may be possible also to reduce expenditures for the refractories making up the thermal furnace and to enhance the durability of the thermal furnace.

### BRIEF DESCRIPTION OF THE DRAWINGS

FIG. 1 is a schematic diagram for explaining the processes which shows a rotary hearth-type thermal reduction furnace.

FIG. 2 is a SiO₂—CaO—TiO₂ ternary phase diagram for cases in which a complex oxide of Al₂O₃, SiO₂, CaO and TiO₂ has an Al₂O₃ content of 20 mass %.

FIG. 3 is a photograph showing the molten state of specimen B-5 after heating at 1500° C.

FIG. 4 is a photograph showing the molten state of specimen B-1 after heating at 1500° C.

### BEST MODE FOR CARRYING OUT THE INVENTION

The inventors have conducted extensive research with the aim of achieving a titanium oxide-containing agglomerate for producing granular metallic iron, which agglomerate is useful for obtaining in a good yield high-quality granular metallic iron suitable for handling by using a titanium oxide-containing iron source that includes TiO₂ and other gangue components and heating at a relatively low temperature compared with conventional processes. As a result, the inventors have found it desirable to increase contents in the agglomerate of both CaO, hitherto been used to promote the formation of slag from the gangue components, and also SiO₂, and to optimize proportion of each content of CaO, Al₂O₃, MgO, SiO₂ and TiO₂ each included in the agglomerate.

Up until now, increasing the content of SiO₂ included in the agglomerate has generally been avoided because such an increase is accompanied by a rise in the slag components. What is distinctive about the present invention is that, by increasing contents of both CaO and SiO₂ included in the agglomerate and by optimizing proportion of each content of CaO, Al₂O₃, MgO, SiO₂ and TiO₂ each within the agglomerate in the manner described above, a better agglomerate melting point depression is achieved than in cases where only the CaO content is increased.

The invention is described in detail below. The inventors used phase diagrams to determine the range in the basicity ([CaO]/[SiO₂]) which will presumably enable a low melting point (from 1300 to 1520° C.) to be achieved in agglomerates containing an iron source that includes titanium oxide of at least 5 mass % but less than 10 mass % in terms of TiO₂-equivalent content (hereinafter, such an iron source is also referred to as “titanium oxide-containing iron source”) and a carbonaceous reductant. As a result, as shown in formula (1) below, the inventors confirmed that by setting the basicity ([CaO]/[SiO₂]) in a range of from 0.6 to 1.2, a low melting point (from 1300 to 1520° C.) can be achieved.

[CaO]/[SiO₂]=0.6 to 1.2 (1)

In formula (1), each of [CaO] and [SiO₂] represents content of each component in the agglomerate (mass % on dry basis). As described above, [CaO] represents sum of a content obtained by converting status of calcium included in the titanium oxide-containing iron source and the carbonaceous reductant into status of CaO, a content obtained by converting status of calcium in the fluorite which may be added as the fluorine-containing material into status of CaO, and a content obtained by converting status of calcium in the calcined lime and limestone (CaCO₃) which may be added as modifiers into status of CaO.

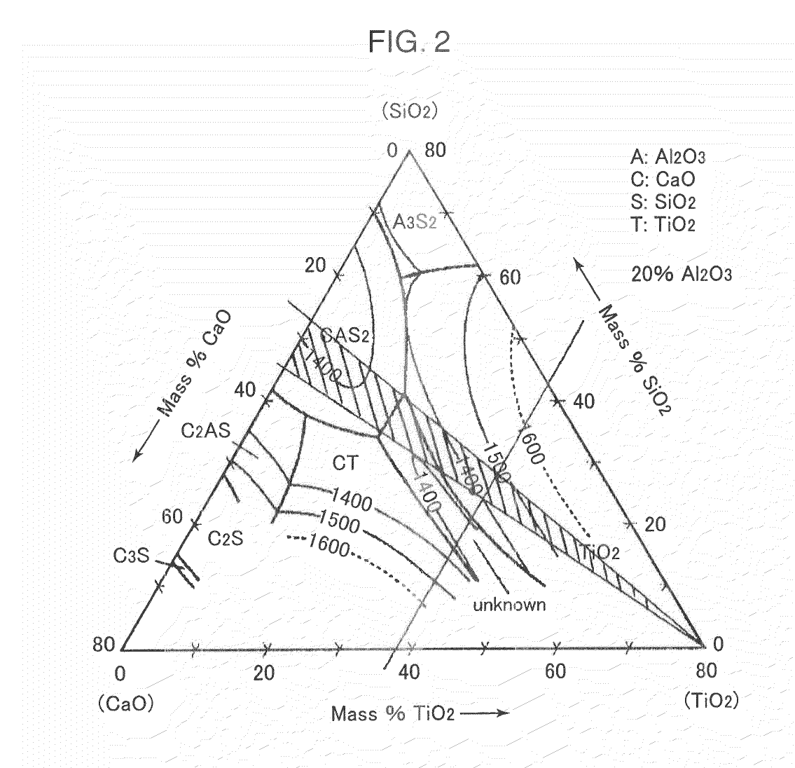

The reasons why the upper limit of [CaO]/[SiO₂] is 1.2 are as follows: (I) on comparing specimen B-3 and specimen B-4 in the subsequently described examples, even when [CaO]/[SiO₂] is increased, the yield of the desired granular metallic iron tends to decrease; and (II) as can be seen in the subsequently described SiO₂—CaO—TiO₂ ternary phase diagram shown in FIG. 2, as the content of CaO increases, the system approaches a high-melting point region.

Next, the inventors carried out experiments in which the above basicity served as a given and other components were also taken into account. It is necessary to consider, as gangue components which exert an influence on the melting point: TiO₂, CaO, SiO₂, Al₂O₃ and MgO. In the case of a complex oxide for which these must be considered at the same time, the melting point cannot be accurately determined from known phase diagrams or computer simulations. The inventors thus carried out experiments, and thereby confirmed the relationship between the TiO₂, CaO, SiO₂, Al₂O₃ and MgO compositions and the melting point.

As a result of these experiments, it has found that the ratio of the content of Al₂O₃ (mass %) to the content of SiO₂ (mass %) included in the agglomerate, that is, [Al₂O₃]/[SiO₂], should be set in a range of from 0.3 to 1.0, as indicated in formula (2) below, in order to set the melting point of the above complex oxide within a range of from 1300° C. to 1520° C., and that the ratio of [TiO₂] to the sum of [CaO], [SiO₂], [MgO] and [Al₂O₃], that is, [TiO₂]/([CaO]+[SiO₂]+[MgO]+[Al₂O₃]), should be set to less than 0.45, as indicated in formula (3) below, with regard to the contents (mass % on dry basis) of respective components in the agglomerate:

[Al₂O₃]/[SiO₂]=0.3 to 1.0 (2)

[TiO₂]/([CaO]+[SiO₂]+[MgO]+[Al₂O₃])<0.45 (3).

The reason why the lower limit of [Al₂O₃]/[SiO₂] is 0.3 is that, in the SiO₂—CaO—Al₂O₃ ternary phase diagram, when the content of Al₂O₃ is too low, the system approaches the high-melting point region.

By thus controlling the proportion of the TiO₂, CaO, SiO₂, MgO and Al₂O₃ included in the agglomerate, a low-melting point composition can be achieved. As a result, with 8 to 15 minutes of heating in a temperature range of from 1300 to 1520° C., the gangue components fully melt, promoting coalescence of the metallic iron, and enabling granular metallic iron having a particle size which is suitable for handling (a particle size of at least 3.35 mm) (granular metallic iron which does not pass through a screen having a mesh size of 3.35 mm) to be obtained in a good yield. The above heating temperature is very low compared with the melting point of titanium oxide (1825° C.). The formation of granular metallic iron of the above size makes it possible to control loss due to scattering during discharge from the thermal furnace. In addition, re-oxidation on exposure to an oxidizing atmosphere can be suppressed, which is particularly effective for preventing the granular metallic iron from igniting during transportation and storage.

The agglomerate of the present invention, aside from being one which contains TiO₂, CaO, SiO₂, MgO and Al₂O₃, may also be one which contains TiO₂, CaO, SiO₂ and Al₂O₃, but does not contain MgO.

The above agglomerate may be (i) one which satisfies the chemical composition conditions set forth in above formulas (1) to (3) within the component ranges of a titanium oxide-containing iron source (e.g., iron ore) and a carbonaceous reductant, or (ii) one which satisfies the chemical composition conditions set forth in above formulas (1) to (3) as a result of the addition of suitable modifiers (e.g., SiO₂-containing material, calcined lime and/or limestone) to the above-mentioned titanium oxide-containing iron source (e.g., iron ore) and carbonaceous reductant. In the case of (ii), the blending amount of such modifiers included should be adjusted after taking into account the gangue components in the titanium oxide-containing iron source (e.g., iron ore) and the composition and content of ash in the carbonaceous reductant (e.g., coal, coke). The specific types of such modifiers are not subject to any particular limitation. As the SiO₂-containing material, use may be made of, for example, not only materials having a high content of silica such as silica sand, but also low-grade limestone or a coal having a high content of silica.

The object of the present invention being to resolve problems when an iron oxide-containing material such as iron ore having a relatively high titanium oxide content is used to produce granular metallic iron, a precondition here is that the titanium oxide-containing iron source which is employed contains titanium oxide of at least 5 mass % but less than 10 mass % in terms of TiO₂-equivalent content.

As used in the invention, “iron source” refers to iron ore, raw material for iron smelting (e.g., iron sand), slag that forms when metal refining is carried out, or a mixture thereof, and one which contains titanium oxide of at least 5 mass % but less than 10 mass % in terms of TiO₂-equivalent content.

The agglomerate according to the present invention enhances the flow properties of the slag that forms as a by-product by additionally including a suitable amount of a fluorine-containing material. Specifically, in order to improve the ability of the slag and the metallic iron to separate and thereby achieve a higher yield (98% or more), the fluorine content in the agglomerate is preferably at least 0.6 mass %, and more preferably at least 0.9 mass %. On the other hand, there are cases in which the use of fluorine is restricted for environmental reasons. Also, because there is a risk that the presence of too much fluorine will excessively increase the flow properties of the slag that forms, accelerating damage due to melting of the hearth refractories, it is preferable for the fluorine content in the agglomerate to be 3.5 mass % or less (and more preferably, 1 mass % or less). Fluorine-containing materials are exemplified by CaF₂-containing materials (e.g., fluorite).

The carbonaceous reductant contained in the agglomerate is required in order to reduce the iron oxide within the titanium oxide-containing iron source. If the amount thereof is too small, reduction of the iron oxide will be inadequate. Inadequate reduction of the iron oxide will give rise to the melting of a large amount of FeO, which may invite damage to the refractories making up the furnace. Therefore, it is desirable for the carbonaceous reductant to be added in such a manner that the atomic molar ratio (O/C) of oxygen bound to iron atoms in the iron source to fixed carbon in all raw materials composing the agglomerate be 1.5 or less (and preferably 1.1 or less).

On the other hand, the presence of excessive carbonaceous reductant in the agglomerate lowers the strength of the agglomerate prior to heating, making it difficult to handle. Also, using a lot of coal or the like as the carbonaceous reductant is undesirable because the content of gangue components will also increase. From these standpoints, it is desirable for the carbonaceous reductant to be added so as to make the above atomic molar ratio (O/C) at least 0.8 (and more preferably at least 1.0).

The specific form of the carbonaceous reductant is not subject to any particular limitation, provided this material contains fixed carbon such as coal, graphite or waste plastic.

In the present invention, it is preferable for at least 90 mass % of the titanium oxide-containing iron source in the agglomerate to have a particle size of 1 mm or less (signifying that it passes through a screen with a mesh size of 1 mm). The use of an iron source of this size is advantageous from the standpoint of heat transfer, in addition to which the reducibility by the carbonaceous reductant present within the agglomerate can be increased. Moreover, this also facilitates forming of the agglomerate. It is more preferable for at least 70 mass % to have a particle size of 200 μm or less (signifying that it passes through a screen having a mesh size of 200 μm) in addition for at least 90 mass % of the titanium oxide-containing iron source to have a particle size of 1 mm or less (signifying that it passes through a screen having a mesh size of 1 mm).

The iron source having the above particle size distribution may be one whose particle size has been adjusted by screen classification, or may be one which has already been made to satisfy the above conditions without such classification.

The agglomerate of the invention contains, as described above, an iron source containing titanium oxide of at least 5 mass % but less than 10 mass % in terms of TiO₂-equivalent content, a carbonaceous reductant (one in powder form is desirable), and materials (modifiers) added where necessary to adjust the chemical composition of the agglomerate so as to satisfy above formulas (1) to (3), in addition to which it may also include a binder for producing the agglomerate.

As used herein, “agglomerate” refers to a material obtained by mixing the above raw materials and agglomerating the resulting mixture. Such agglomeration is carried out using any of various known devices, examples of which include presses such as briquetting presses (e.g., cylinder briquette press, roller briquette press, ring roller briquette press), and also extruders and tumbling granulators (e.g., pan pelletizer, drum pelletizer).

The shape of the agglomerate is not subject to any particular limitation. Any of various shapes may be used, such as blocky, granular, briquette-like, pellet-like or rodlike.

The granular metallic iron is produced by reducing and melting the agglomerate, although there is no limitation on the method of reduction and melting. A known reducing and melting furnace may be used for such reduction and melting. A method of producing granular metallic iron using a movable hearth-type thermal reduction furnace is described below by way of illustration, although this is not intended to limit the invention.

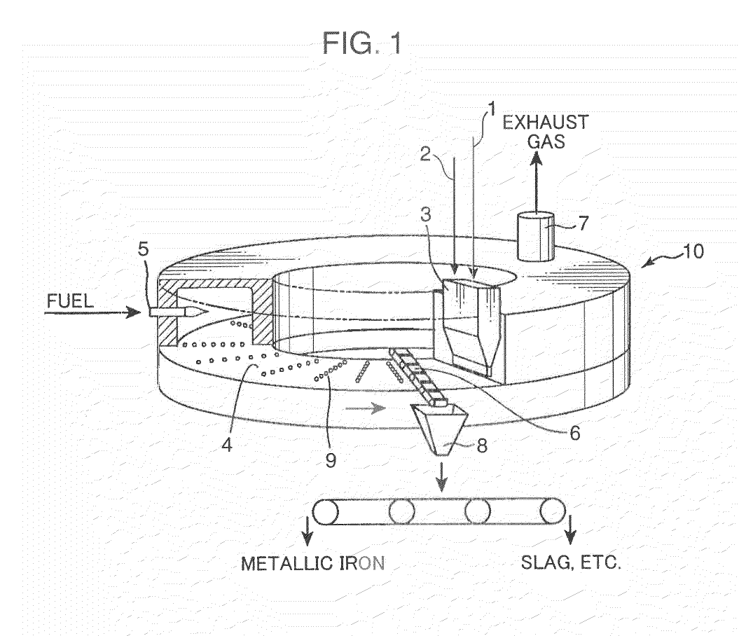

FIG. 1 is a schematic diagram for explaining the processes in the method for producing the above granular metallic iron. In FIG. 1, a rotary hearth thermal reduction furnace 10 having a rotary hearth 4 is shown as the movable hearth-type thermal reduction furnace.

The above agglomerate 1, and a powdery carbonaceous material 2 which is preferably supplied as a bed material, are fed into the rotary hearth-type thermal reduction furnace 10. These materials pass through a material feed hopper 3 and are continuously charged onto the rotary hearth 4. More specifically, prior to charging of the agglomerate 1, the powdery carbonaceous material 2 is charged from the material feed hopper 3 and onto the rotary hearth 4, over which it is spread, following which the agglomerate 1 is charged thereon. FIG. 1 shows an example in which a single material feed hopper 3 is used to charge both the agglomerate 1 and the carbonaceous material 2. However, the agglomerate 1 and the carbonaceous material 2 may be separately charged through two or more hoppers. The carbonaceous material 2 charged as the bed material increases the reducing efficiency, in addition to which it is very effective for promoting low sulfurization of the granular metallic iron that is obtained. However, in some cases, it may be omitted.

The rotary hearth 4 rotates in the counterclockwise direction in FIG. 1. The speed of rotation varies according to the operating conditions, but typically the rotary hearth 4 makes one turn in about 8 to 16 minutes. During this time, the iron oxide included in the agglomerate 1 is solid-reduced, the melting point of the resulting reduced iron depresses due to decarburization, the reduced iron coalesces into granular while being separated from slag formed as a by-product, and then, granular metallic iron is formed.

Specifically, in the reducing reaction 10, a plurality of combustion burners 5 are provided on the sidewalls and/or the roof so as to be positioned above the rotary hearth 4. Heat from combustion of the burners 5 or radiant heat therefrom is supplied to the hearth. At the same time, the agglomerate 1 that has been charged onto the rotary hearth 4 made of a refractory material is heated by the heat of combustion from the burners 5 or radiant heat as it moves circumferentially together with the hearth 4 inside the reduction furnace 10. During the period that this agglomerate 1 passes through the heating zone within the reduction furnace 10, iron oxide in the agglomerate 1 is solid-reduced; the reduced iron is separated from the molten slag formed as a by-product, while the reduced iron is decarburized by the remaining carbonaceous reductant, softens, and granularly coalesces; the reduced iron becomes granular metallic iron 9. The granular metallic iron 9 is then cooled and solidified in a downstream side zone of the rotary health furnace 4, after which it is discharged from the hearth and through a hopper 8 by means of a discharging apparatus 6 such as a screw. The gas that has evolved within the furnace is exhausted through an exhaust gas duct 7.

Thermal reduction proceeds on the rotary hearth, and when reduction of the iron oxide in the agglomerate is substantially complete, reduced iron particles having a high iron purity comparable to that of pure iron form. These reduced iron particles are rapidly decarburized with the remaining carbonaceous reductant present in the agglomerate. Moreover, the melting point of the reduced iron undergoes a large decrease as the content of carbon in the reduced iron increases, the reduced iron begins to melt at a specific atmospheric temperature (e.g., from 1350 to 1500° C.), and the resulting fine granular reduced iron mutually coalesces, ultimately forming granular metallic iron in the form of large particles. In this melting and coalescing process, the slag-forming components included in the agglomerate also melt and separate from the granular metallic iron while mutually coalescing.

### Examples

The invention is described in greater detail below by way of examples. The following examples are not intended to limit the invention, and may be practiced with suitable modifications without departing from the scope of the invention as described above and below, all such modifications falling within the technical scope of the invention.

### Example 1

Table 1 shows the chemical composition of the titanium oxide-containing iron ore used in this example. In the field of metallurgy, an equilibrium phase diagram is generally used to infer the melting temperature of an oxide. In this example, first the phase diagram closest to the gangue component composition of the titanium oxide-containing iron ore shown in Table 1 was selected (FIG. 2). Using this FIG. 2, proper values for [CaO]/[SiO₂] at which it is estimated that the melting temperature will become 1450° C. or less were determined to be from 0.52 to 0.82 (the shaded zone shown in FIG. 2). Based on these proper values, the proportions of each raw material were determined as shown in Table 2. Table 3 shows the chemical composition of the coal shown in Table 2.

TABLE 1
Chemical composition of iron ore (mass %)

| T•Fe | FeO | SiO₂ | Al₂O₃ | MgO | TiO₂ |
|---|---|---|---|---|---|
| 59.38 | 29.95 | 2.00 | 3.79 | 2.81 | 7.69 |

TABLE 2

| | Proportions of raw materials (mass %) | | | | | |
|---|---|---|---|---|---|---|
| Specimen | Iron | | | | | |
| symbol | ore | Coal | Limestone | Fluorite | Silica | Binder |
| B-1 | 78.153 | 18.252 | 2.095 | 0.000 | 0.000 | 1.500 |
| B-2 | 77.421 | 18.081 | 2.098 | 0.900 | 0.000 | 1.500 |
| B-3 | 72.458 | 16.922 | 5.426 | 0.902 | 2.792 | 1.500 |

TABLE 3

| Chemical composition | | | | | | | |
|---|---|---|---|---|---|---|---|
| of coal (mass %) | | | | | | | |
| | | Fixed | Components in ash (mass %) | | | | |
| Volatiles | Ash | carbon | SiO₂ | Al₂O₃ | CaO | MgO | TiO₂ |
| 10.08 | 10.77 | 79.15 | 54.17 | 29.79 | 3.51 | 1.18 | 1.61 |

On the other hand, because it is impossible with one phase diagram to consider at the same time a larger number of gangue components and estimate the melting temperature, such estimates were carried out using a computer. Specifically, by using “melting point estimating software” created based on cumulative data on the relationship between the types and contents of gangue components and the melting temperature and on thermodynamic estimates, the approximate melting points for specimens B-1 to B-3 in Table 2 were predicted. These results are shown in Table 4. The value of the slag liquid phase temperature for specimen A-1 shown in Table 4 is the result obtained by estimating the melting point for specimen B-1. Similarly, specimen A-2 corresponds to specimen B-2, and specimen A-3 corresponds to specimen B-3. Also, the basicity of specimen A-1 and the basicity of specimen A-2 differ because values of the component contents input to the computer varied when the calcium in fluorite was taken into account.

TABLE 4

| | | | | Liquid phase |
|---|---|---|---|---|
| Specimen | CaO/SiO₂ | TiO₂/SiO₂ | Al₂O₃/SiO₂ | temperature of slag |
| symbol | (—) | (—) | (—) | (° C.) |
| A-1 | 0.599 | 2.322 | 1.365 | 1496 |
| A-2 | 0.700 | 2.312 | 1.360 | 1518 |
| A-3 | 0.700 | 1.090 | 0.643 | 1418 |

This Table 4 shows that the melting temperature (slag liquid phase temperature) of specimen A-2 having a high basicity ([CaO]/[SiO₂]) exceeds 1500° C. Specimen A-3 has the same basicity as specimen A-2, but the content of SiO₂ therein increased. The possibility that the melting temperature estimated for this specimen A-3 becomes 1450° C. or less was confirmed.

The iron ore, coal, modifiers (specifically, limestone, and also, if necessary, fluorite, silica, etc.) and binder shown in Table 2 were mixed together, and the resulting powder raw material was formed with a pan pelletizer into spherical pellets having a diameter of 19 mm (agglomerate). Separately, a mixture of the powder raw material with water was inserted into a cylinder, and a pressure of 0.3 ton/cm² was applied from above, thereby forming disk-shaped tablets (15 mm high, 20 mm diameter). Material having a particle size of 1 mm or less (material which passed through a screen having a mesh size of 1 mm) was used for the entire mass of each of the above iron ore, coal, modifier and binder.

Table 5 shows the chemical analysis (chemical compositions) for the pellets formed in this way from specimens B-1, B-2 and B-3, and for the formed tablets a, b and c. The chemical compositions of specimens a, b and c were computed from the analysis values for each of the raw materials prior to mixture and their respective proportions.

TABLE 5

| | | | | | | | | | | Component ratio (—) | | | |
|---|---|---|---|---|---|---|---|---|---|---|---|---|---|
| Specimen | Agglomerate | Chemical composition of agglomerate (mass %) | | | | | | | | | | TiO₂/ | |
| symbol | shape | T•Fe | FeO | SiO₂ | Al₂O₃ | CaO | MgO | TiO₂ | F | CaO/SiO₂ | Al₂O₃/SiO₂ | (C + S + M + A)* | O/C |
| B-1 | pellet | 46.90 | 25.76 | 2.60 | 3.62 | 1.59 | 2.36 | 5.71 | — | 0.612 | 1.392 | 0.561 | 0.897 |
| B-2 | pellet | 46.50 | 24.81 | 2.57 | 3.56 | 2.21 | 2.30 | 5.67 | 0.43 | 0.860 | 1.385 | 0.533 | 0.902 |
| B-3 | pellet | 43.72 | 23.00 | 3.45 | 3.34 | 4.00 | 3.16 | 6.04 | 0.39 | 1.159 | 0.968 | 0.433 | 0.909 |
| a | tablet | 46.49 | 23.41 | 2.63 | 3.55 | 1.56 | 2.23 | 5.99 | 0.00 | 0.592 | 1.349 | 0.606 | 0.902 |
| b | tablet | 46.05 | 23.19 | 2.62 | 3.52 | 2.19 | 2.21 | 5.68 | 0.43 | 0.835 | 1.344 | 0.568 | 0.902 |
| c | tablet | 43.12 | 22.01 | 5.23 | 3.40 | 3.12 | 2.11 | 5.60 | 0.00 | 0.598 | 0.650 | 0.410 | 0.902 |

*Remarks: C indicates CaO, S indicates SiO₂, M indicates MgO and A indicates Al₂O₃.

Because the values of [CaO]/[SiO₂] and [Al₂O₃]/[SiO₂] in Table 4 were estimated from the proportions of the raw materials in order to determine the melting temperature of the agglomerate, they differ from the Table 5 values obtained by actually producing pellets or tablets and carrying out analysis on these pellets or tablets.

The pellets or tablets were moved into an electric furnace heated to 1500° C. or 1450° C. and having a nitrogen atmosphere, and were heated. At the point in time where the evolution of carbon monoxide gas within the furnace ceased and the separation of metallic iron was visually confirmed, the respective specimens were removed to a cooling zone, thereby completing the test. The metallic iron and slag were later separated by hand.

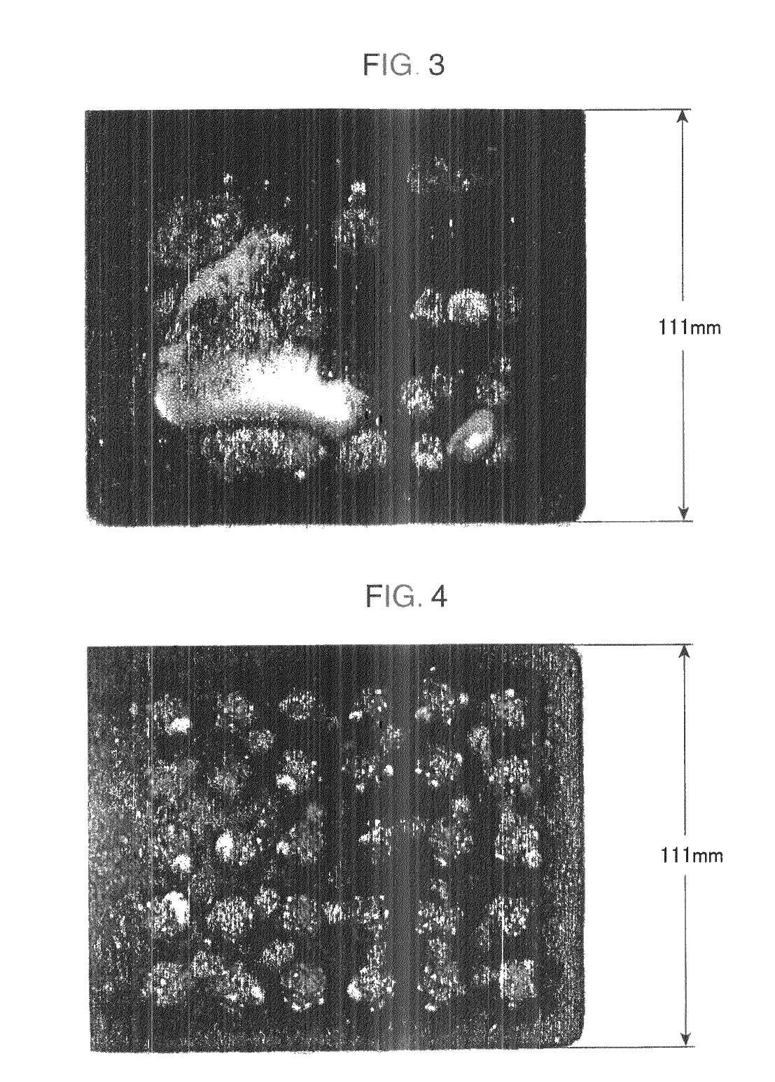

FIG. 3 is a photograph showing the molten state after specimen B-5 in the example of the invention was heated at 1500° C. The whitish-gray spherical particles in the photograph are slag, and the blackish-gray spherical particles are metallic iron. This photograph shows that slag and metallic iron fully separate when specimen B-5 is heated at 1500° C. It was also confirmed that, in other specimens which satisfy all the conditions indicated by above formulas (1) to (3), as with specimen B-5, the slag and metallic iron fully separate.

FIG. 4 shows a photograph of the molten state after above specimen B-1 was heated to 1500° C. The spherical particles in this photograph which are whitish-gray (including those areas which are blue in a color photograph) are slag, and the blackish-gray areas are slag-containing metallic iron. From this photograph, it was found that when specimen B-1 is heated at 1500° C., compared with above specimen B-5 shown in FIG. 3, the slag and metallic iron melt, but separation therebetween is insufficient. It was also confirmed that, in other specimens which did not satisfy at least one of the conditions indicated by above formulas (1) to (3), as with specimen B-1, mutual separation of the slag and metallic iron was inadequate.

Next, the ratio of the amount of granular metallic iron having a particle size of at least 3.35 mm (granular metallic iron which does not pass through a screen having a mesh size of 3.35 mm and remains instead on the screen) with respect to the iron content in the pellet or tablet was determined as the yield. Those results are shown in Table 6.

TABLE 6

| | | | | | Metallic iron | Yield (metallic iron particles |
|---|---|---|---|---|---|---|
| | | | Ratio of | | particles having | having breadths of not less |
| | Heating | | metallic | Metallic | breadths not | than 3.35 mm with respect to |
| Specimen | Temperature | Specimen | iron | iron | less than 3.35 mm | the whole metallic iron) |
| symbol | (° C.) | (g) | (mass %) | (g) | (g) | (mass %) |
| B-1 | 1500 | 229.9 | 46.90 | 107.82 | 44.18 | 40.97 |
| B-2 | 1500 | 237.36 | 46.50 | 110.37 | 64.03 | 58.01 |
| B-3 | 1500 | 230.07 | 43.72 | 100.59 | 80.78 | 80.31 |
| a | 1450 | 49.05 | 46.49 | 22.8 | 9.09 | 29.41 |
| b | 1450 | 49.17 | 46.06 | 22.65 | 12.16 | 39.56 |
| c | 1450 | 48.38 | 43.73 | 21.16 | 5.56 | 17.99 |

As shown in Table 6, specimen B-1, in which limestone alone was added as a modifier, had a very low yield of granular metallic iron with a particle size of at least 3.35 mm (granular metallic iron which does not pass through a screen with a mesh size of 3.35 mm) of about 41%, and thus was not practically useful. Even in specimen B-2, which had substantially the same formulation as specimen B-1 but to which fluorine for improving the flow properties of the slag was also added, the improving effect was small, with the yield being only about 58%.

Specimens a and b which do not fulfill all of the conditions in formulas (1) to (3) also had respective yields of only about 29% and about 40%.

In addition, the result for specimen c teaches that, even when the SiO₂ content in the agglomerate is increased, if all the conditions in formulas (1) to (3) are not satisfied, the above-described granular metallic iron cannot be obtained in a high yield.

By contrast, in specimen B-3, wherein the SiO₂ content in the composition of specimen B-2 was increased, by lowering the value of [Al₂O₃]/[SiO₂] to 0.6 and thereby adjusting the chemical composition so as to satisfy all the conditions in formulas (1) to (3), the yield of granular metallic iron having a particle size of at least 3.35 mm (granular metallic iron which does not pass through a screen having a mesh size of 3.35 mm) rose markedly to about 80%.

### Example 2

A test was carried out in order to further corroborate the notion that, in order to achieve a high yield of granular metallic iron when titanium oxide-containing iron ore is used, it is effective to increase the SiO₂ content in the agglomerate and adjust the chemical composition so as to satisfy all the conditions of formulas (1) to (3) specified in the present invention.

Iron ore of the composition shown in Table 1, coal of the composition shown in Table 3, and modifiers (specifically, limestone, fluorite and silica) were mixed together along with binder in the same way as in Example 1, and formed into pellets (agglomerate). The chemical composition of these pellets (dry pellets) is shown in Table 7. In Table 7, specimen B-4 was obtained by increasing the content of SiO₂ even further than in specimen B-3. Specimen B-5 had substantially the same composition as specimen B-4, aside from an increase in the content of carbon. Specimen B-6 had substantially the same composition as specimen B-4, aside from an even further increase in the content of SiO₂ than in specimen B-4 and a slight increase in the content of CaO.

TABLE 7

| | | | | | | | | | | Component ratio (—) | | | |
|---|---|---|---|---|---|---|---|---|---|---|---|---|---|
| Specimen | Chemical composition of dry pellet (mass %) | | | | | | | | | | | TiO₂/ | |
| symbol | T•Fe | FeO | SiO₂ | Al₂O₃ | CaO | MgO | TiO₂ | F | T.C | CaO/SiO₂ | Al₂O₃/SiO₂ | (C + S + M + A)* | O/C |
| B-4 | 44.110 | 23.660 | 5.200 | 3.320 | 4.600 | 2.120 | 5.620 | 0.670 | 12.070 | 0.885 | 0.618 | 0.369 | 1.234 |
| B-5 | 43.490 | 22.140 | 5.160 | 3.310 | 4.470 | 2.100 | 5.570 | 0.670 | 14.090 | 0.866 | 0.620 | 0.370 | 1.105 |
| B-6 | 41.960 | 20.580 | 7.080 | 3.190 | 5.860 | 2.040 | 5.410 | 0.660 | 11.450 | 0.828 | 0.454 | 0.298 | 1.222 |

*Remarks: C indicates CaO, S indicates SiO₂, M indicates MgO and A indicates Al₂O₃.

As in Example 1 above, these specimens were moved into an electric furnace heated to 1500° C. and having a nitrogen atmosphere, and were heated. At the point in time where the evolution of carbon monoxide gas ceased and the separation of metallic iron was visually confirmed, the specimens were removed to a cooling zone, thereby completing the test. The metallic iron and slag were later separated by hand. The ratio of the amount of granular metallic iron having a particle size of at least 3.35 mm (granular metallic iron which does not pass through a screen having a mesh size of 3.35 mm and remains instead on the screen) with respect to the iron content in the pellet was determined as the yield. Those results are shown in Table 8.

TABLE 8

| | | | | | Metallic iron | | Yield (metallic iron particles |
|---|---|---|---|---|---|---|---|
| | | | Ratio of | | particles having | | having breadths of not less |
| | Heating | | metallic | Metallic | breadths not | | than 3.35 mm with respect to |
| Specimen | Temperature | Specimen | iron | iron | less than 3.35 mm | Slag | the whole metallic iron) |
| symbol | (° C.) | (g) | (mass %) | (g) | (g) | (g) | (mass %) |
| B-4 | 1500 | 243.29 | 44.11 | 107.32 | 109.98 | 55.17 | 102.48 |
| B-5 | 1500 | 235.68 | 43.49 | 102.50 | 105.03 | 52.66 | 102.47 |
| B-6 | 1500 | 225.14 | 43.10 | 97.04 | 97.13 | 51.76 | 100.10 |
| B-4′ | 1450 | 236.97 | 44.11 | 104.53 | 102.84 | 55.83 | 98.39 |

As shown in Table 8, in specimen B-4, which has an even higher content of SiO₂ than sample B-3, the yield of granular metallic iron having a particle size of at least 3.35 mm (granular metallic iron which does not pass through a screen having a mesh size of 3.35 mm) rose markedly to 102.5%. The reason why this yield exceeds 100% is that, as shown in Table 9, carbon and various trace ingredients are present in the metallic iron. This Table 9 shows the chemical analysis of carbon, silicon, sulfur and titanium in the metallic iron.

TABLE 9

| | | |
|---|---|---|
| | Heating | Melted constituents in |
| Specimen | Temperature | metallic iron (mass %) |

| symbol | (° C.) | C | Si | S | Ti |
|---|---|---|---|---|---|
| B-4 | 1500 | 3.28 | 0.07 | 0.103 | 0.02 |
| B-5 | 1500 | 3.48 | 0.1 | 0.092 | 0.04 |
| B-6 | 1500 | 3.44 | 0.05 | 0.123 | 0.01 |
| B-4′ | 1450 | 3.32 | 0.07 | 0.095 | 0.03 |

From Table 9, because the carbon content in specimen B-4 was 3.28%, when this is excluded, the yield of granular metallic iron having a particle size of at least 3.35 mm (granular metallic iron which does not pass through a screen having a mesh size of 3.35 mm) becomes 99.2%.

On the other hand, in specimen B-5 having an increased content of carbon, based on the change in the rate of reduction calculated from an analysis of the exhaust gas, it was confirmed that reduction of the iron oxide proceeds well. However, the yield of granular metallic iron having a particle size of at least 3.35 mm (granular metallic iron which does not pass through a screen having a mesh size of 3.35 mm) in this specimen B-5 was 102.5%, which was substantially the same as in specimen B-4. This shows that increasing the blending ratio of carbon does not have an effect on the yield of granular metallic iron with a particle size of at least 3.35 mm (granular metallic iron which does not pass through a screen having a mesh size of 3.35 mm).

Specimen B-6 is a specimen in which the content of SiO₂ was increased even further than in specimen B-4. However, the yield of granular metallic iron having a particle size of at least 3.35 mm (granular metallic iron which does not pass through a screen having a mesh size of 3.35 mm) in this specimen B-6 was substantially the same as in specimen B-4. This shows that excessively increasing the SiO₂ does not improve the yield.

A test was carried out also for a case in which, using specimen B-4, the heating temperature was lowered from 1500 to 1450° C. Those results are shown in Table 8 under the specimen symbol B-4′. As is apparent from Table 8, when the heating temperature is lowered from 1500 to 1450° C., the yield of granular metallic iron having a particle size of at least 3.35 mm (granular metallic iron which does not pass through a screen having a mesh size of 3.35 mm) was observed to decrease about 4% compared with when the heating temperature was set to 1500° C. (B-4). In the case of specimen B-4′, lowering the heating temperature lengthens the heating time somewhat; letting the heating time for specimen B-4 be 1, the heating time for specimen B-4′ was 1.19.

As described above, the present invention provides, in cases where a titanium oxide-containing iron source that includes, in addition to TiO₂, the gangue components which increase the melting temperature such as Al₂O₃ and MgO is used in the production of granular metallic iron, a titanium oxide-containing agglomerate for producing granular metallic iron that is useful for obtaining in a good yield high-quality granular metallic iron of the above-indicated size by reducing and melting iron oxide via heating at a relatively low temperature compared with conventional processes (heating at a temperature, at the burden top surface position when the burden is not present, of 1520° C. or less). This titanium oxide-containing agglomerate for producing granular metallic iron comprises: an iron source including titanium oxide of at least 5 mass % but less than 10 mass % in terms of TiO₂-equivalent content; and a carbonaceous reductant, wherein the agglomerate has a chemical composition satisfying a condition set forth in formulas (1) to (3) below,

[CaO]/[SiO₂]=0.6 to 1.2 (1)

[Al₂O₃]/[SiO₂]=0.3 to 1.0 (2)

[TiO₂]/([CaO]+[SiO₂]+[MgO]+[Al₂O₃])<0.45 (3).

Each of [CaO], [SiO₂], [Al₂O₃], [TiO₂] and [MgO] in the formulas (1) to (3) represents content (mass % on dry basis) of each components in the agglomerate.

[TiO₂] corresponds to the above-mentioned TiO₂-equivalent content. This equivalent content refers to, in cases where the agglomerate includes not only TiO₂ but also other titanium oxides such as Ti₂O₃ or TiO, the content which is obtained by converting statuses of these other titanium oxides into status of TiO₂ is also added in the TiO₂-equivalent content. Specifically, this [TiO₂] (TiO₂-equivalent content), assuming that metallic titanium is not also present, may be calculated from the following formula (4).

[TiO₂] (wt %)=content of all the titanium (wt %)/(atomic weight of titanium)×{(atomic weight of titanium)+2×(atomic weight of oxygen)} (4)

[CaO] represents sum of a content obtained by converting status of calcium included in the titanium oxide-containing iron source and the carbonaceous reductant into status of CaO, a content obtained by converting status of calcium in the fluorite which may be added as the fluorine-containing material into status of CaO, and a content obtained by converting status of calcium in the calcined lime and limestone (CaCO₃) which may be added as modifiers into status of CaO. Specifically, this [CaO], assuming that metallic calcium is not also present, may be calculated from the following formula (5).

[CaO] (wt %)=content of all the calcium (wt %)/(atomic weight of calcium)×{(atomic weight of calcium)+(atomic weight of oxygen)} (5)

This agglomerate makes it possible to produce in a good yield, and at a relatively low heating temperature, high-quality granular metallic iron of a size that is suitable for handling, even in cases where an iron source containing TiO₂ and other gangue components is used in the production of the granular metallic iron. As a result, not only can the fuel costs for heating be reduced, it may be possible also to reduce expenditures for the refractories making up the thermal furnace and to enhance the durability of the thermal furnace.

Preferably, the above agglomerate further comprises a fluorine-containing material, wherein the fluorine content of the agglomerate is from 0.6 to 3.5 mass %.

Preferably, in the above agglomerate, the carbonaceous reductant is added in such a manner that the atomic molar ratio (O/C) of oxygen bound to iron atom in the iron source to fixed carbon in all raw materials composing the agglomerate is from 0.8 to 1.5.

Preferably, in the above agglomerate, at least 90 mass % of the iron source has a particle size of 1 mm or less, i.e., at least 90 mass % of the iron source has a particle passing through a screen having a mesh size of 1 mm.

1. A titanium oxide agglomerate comprising:
an iron source comprising titanium oxide of at least 5 mass % but less than 10 mass % in terms of TiO₂-equivalent content; and
a carbonaceous reductant, wherein
the agglomerate has a chemical composition satisfying a condition set forth in formulas (1) to (3) below,
[CaO]/[SiO₂]=0.6 to 1.2 (1)
[Al₂O₃]/[SiO₂]=0.3 to 1.0 (2)
[TiO₂]/([CaO]+[SiO₂]+[MgO]+[Al₂O₃])<0.45 (3)
wherein each of [CaO], [SiO₂], [Al₂O₃], [TiO₂] and [MgO] in the formulas (1) to (3) represents content, based on mass % on dry basis, of each component in the agglomerate, [TiO₂] represents the TiO₂-equivalent content obtained by converting statuses of all titanium oxides in the agglomerate into status of TiO₂, and [CaO] represents a content obtained by converting statuses of all the calcium in the agglomerate into status of CaO.

2. The titanium oxide agglomerate according to claim 1, further comprising a fluorine material, wherein the fluorine content of the agglomerate is from 0.6 to 3.5 mass %.

3. The titanium oxide agglomerate for producing granular metallic iron according to claim 1, wherein the carbonaceous reductant is added in such a manner that the atomic molar ratio (O/C) of oxygen bound to iron atom in the iron source to fixed carbon in all raw materials composing the agglomerate is from 0.8 to 1.5.

4. The titanium oxide agglomerate for producing granular metallic iron according to claim 1, wherein at least 90 mass % of the iron source has a particle size of 1 mm or less.
